(19) United States
(12) Patent Application Publication
(10) Pub. No.: US 2021/0356430 A1
(43) Pub. Date: Nov. 18, 2021

(54) ANALYZER

(71) Applicant: SHARP KABUSHIKI KAISHA, Sakai City (JP)

(72) Inventors: TOMOHIRO KOSAKA, Sakai City (JP); YUUKI OOTSUKA, Sakai City (JP); TOMOKO TERANISHI, Sakai City (JP); KEI IKUTA, Yonago-shi (JP)

(21) Appl. No.: 17/318,878

(22) Filed: May 12, 2021

Related U.S. Application Data
(60) Provisional application No. 63/025,733, filed on May 15, 2020.

(51) Int. Cl. G01N 27/624

(52) U.S. Cl. CPC G01N 27/624

(57) ABSTRACT

An analyzer includes: a flow path component providing a flow path through which a sample is supplied from an inlet end thereof toward an outlet end thereof; an ionization unit that ionizes the sample flowing in the flow path to produce ions; a pair of voltage application electrodes located opposite each other across the flow path and closer to the outlet end than the ionization unit is located close to the outlet end, an asymmetric-waveform, high-frequency voltage being applied to the ions through the pair of voltage application electrodes; a detection electrode located closer to the outlet end than the pair of voltage application electrodes is located close to the outlet end; a deflection electrode located opposite the detection electrode across the flow path, the deflection electrode generating a DC electric field that moves the ions toward the detection electrode; and a reference electrode located not opposite the deflection electrode.

### BACKGROUND OF THE INVENTION

Japanese Patent No. 5570645, as an example, discloses a field asymmetric ion mobility filter system. This filter system includes a flow path between a sample inlet and an outlet. There is provided an ion filter in the flow path. The ion filter includes s pair of opposite electrodes to which an asymmetric signal is applied to generate an electric field. In this filter system, different ionic species are separated in accordance with the ion mobility thereof in the electric field by selectively adjusting the duty cycle of the asymmetric waveform. The separated ions are captured by the electrodes in the detector to detect the quantity thereof.

### SUMMARY OF THE INVENTION

There is a demand for improvements in the analytical precision of devices that utilize ion mobility for ionic analysis like the foregoing filter system.

The present disclosure has a primary object to provide an analyzer with high analytical precision.

The present invention, in an aspect thereof, is directed to an analyzer including: a flow path component providing a flow path through which a sample is supplied from an inlet end thereof toward an outlet end thereof an ionization unit that ionizes the sample flowing in the flow path to produce ions; a pair of voltage application electrodes located opposite each other across the flow path and closer to the outlet end than the ionization unit is located close to the outlet end, an asymmetric-waveform, high-frequency voltage being applied to the pair of voltage application electrodes; a detection electrode located closer to the outlet end than the pair of voltage application electrodes is located close to the outlet end; a deflection electrode located opposite the detection electrode across the flow path, the deflection electrode generating a DC electric field that moves the ions toward the detection electrode; and a reference electrode located not opposite the deflection electrode.

### BRIEF DESCRIPTION OF DRAWINGS

FIG. 1 is a schematic cross-sectional view of am analyzer in accordance with a first embodiment.

FIG. 2 is a schematic plan view of a first wall section.

FIG. 3 is a schematic plan view of a second wall section.

FIG. 4 is a graph representing an exemplary voltage applied to a pair of voltage application electrodes.

FIG. 5 is a schematic cross-sectional view of an analyzer in accordance with a second embodiment.

FIG. 6 is a schematic cross-sectional view of an analyzer in accordance with a third embodiment.

FIG. 7 is a schematic cross-sectional view of an analyzer in accordance with a fourth embodiment.

FIG. 8 is a schematic cross-sectional view of an analyzer in accordance with a fifth embodiment.

FIG. 9 is a schematic cross-sectional view of an analyzer in accordance with a sixth embodiment.

FIG. 10 is a schematic plan view of a second wall section in accordance with a seventh embodiment.

FIG. 11 is a schematic plan view of a first wall section in accordance with an eighth embodiment.

FIG. 12 is a schematic plan view of a second wall section in accordance with the eighth embodiment.

### DETAILED DESCRIPTION

The following will describe an example of a preferred embodiment of the present invention. The embodiment is a mere example and does not limit the scope of the present invention.

### First Embodiment

### Structure of Analyzer 1

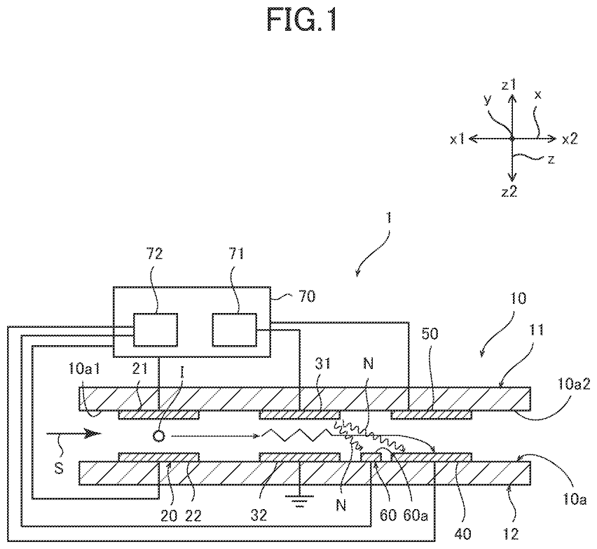

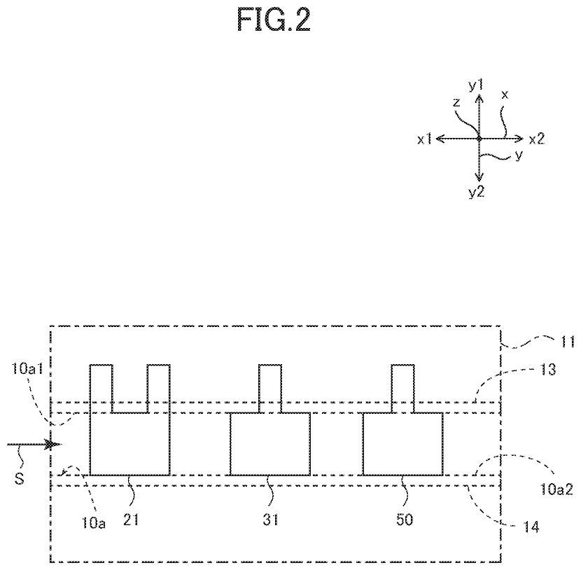

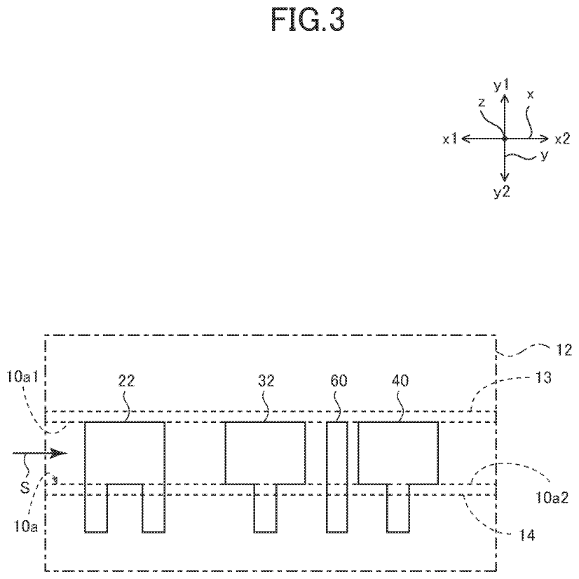

FIG. 1 is a schematic cross-sectional view of an analyzer 1 in accordance with a first embodiment. FIG. 2 is a schematic plan view of a first wall section 11. FIG. 3 is a schematic plan view of a second wall section 12.

The analyzer 1, shown in FIG. 1, separates specific ionic species from a plurality of ionic species and analyzes the concentration of the separated ionic species. To separate different ionic species, the analyzer 1, for example, utilizes the fact that different ionic species move in different directions in an electric field generated when an asymmetric-waveform, high-frequency voltage is applied. The analyzer 1 in accordance with the present embodiment is specifically a field asymmetric ion mobility spectrometer (FA-IMS). The analyzer in accordance with the present invention is not necessarily an FA-IMS.

The analyzer 1 includes a flow path component 10, an ionization unit 20, a pair of first and second voltage application electrodes 31, 32, a detection electrode 40, a deflection electrode 50, a reference electrode 60, and a control unit 70.

The flow path component 10 is a structural part of a flow path 10a. The flow path 10a extends from an x1 side (inlet end) toward an x2 side (outlet end) of the x-axis.

Specifically, the flow path component 10 includes the first wall section 11, the second wall section 12, a first sidewall section 13 (see FIGS. 2 and 3), and a second sidewall section 14 (see FIGS. 2 and 3).

The first wall section 11 and the second wall section 12 are located opposite each other across the flow path 10a. The first wall section 11 and the second wall section 12 are located opposite each other with respect to the z-axis direction which is vertical to the x-axis direction. Specifically, the first wall section 11 is located on the z1 side of the flow path 10a with respect to the z-axis direction, and the second wall section 12 is located on the z2 side of the flow path 10a with respect to the z-axis direction. The first wall section 11 and the second wall section 12 are platelike members that extend in both the x-axis direction and the y-axis direction which is vertical to both the x-axis direction and the z-axis direction.

The first sidewall section 13 and the second sidewall section 14, shown in FIGS. 2 and 3, are located between the first wall section 11 and the second wall section 12. Each of the first sidewall section 13 and the second sidewall section 14 is connected to both the first wall section 11 and the second wall section 12. The first sidewall section 13 and the second sidewall section 14 are separated by a distance and located opposite each other with respect to the y-axis direction. The first sidewall section 13 and the second sidewall section 14 extend in the x-axis direction. The first sidewall section 13, the second sidewall section 14, the first wall section 11, and the second wall section 12 form the flow path 10a with a generally rectangular horizontal cross-section.

The flow path 10a has, at or near the inlet end (x1 side) thereof, an end portion 10a1 connected to a sample feeding unit (not shown). The sample feeding unit supplies a sample (specimen) S to be analyzed into the flow path 10a through the end portion 10a1 (inlet end). The sample S is preferably a gas as an example. The sample S is more preferably a gas containing ionizable molecules.

The flow path 10a has, at or near the outlet end (x2 side) thereof, an end portion 10a2 connected to a pump (not shown). The pump sucks gas out of the flow path 10a. The sample S supplied from the sample feeding unit is therefore transported from the inlet end toward the outlet end of the flow path 10a.

The ionization unit 20, shown in FIG. 1, ionizes at least some of the molecules in the sample S flowing in the flow path 10a to produce ions I. Typically, a plurality of species of ions I is produced from the sample S. The ionization unit 20 is not limited in any particular manner as long as the ionization unit 20 is capable of ionizing the sample S. The ionization unit 20 may include, for example, a pair of electrodes 21, 22 located opposite each other across the flow path 10a.

The voltage application electrodes 31, 32 are a part of an ion separation unit that separates specific ions I from a plurality of species of ions I. The voltage application electrodes 31, 32 are located closer to the outlet (x2) than is the ionization unit 20 with respect to the x-axis direction along which the flow path 10a extends. The voltage application electrodes 31, 32 are located opposite each other across the flow path 10a. Specifically, the first voltage application electrode (first electrode) 31 is provided on the first wall section 11, and the second voltage application electrode (second electrode) 32 is provided on the second wall section 12. More specifically, the first voltage application electrode 31 is disposed on a primary surface of the first wall section 11 opposite the second wall section 12, and the second voltage application electrode 32 is disposed on a primary surface of the second wall section 12 opposite the first wall section 11.

An asymmetric-waveform, high-frequency voltage is applied to the voltage application electrodes 31, 32. In the present embodiment, an asymmetric-waveform, high-frequency voltage is applied to the first voltage application electrode 31 on the first wall section 11. The second voltage application electrode 32 on the second wall section 12 is grounded.

The detection electrode 40 is located closer to the outlet than are the voltage application electrodes 31, 32 with respect to the x-axis direction. The detection electrode 40 is disposed inside the flow path 10a. The detection electrode 40 can be disposed on either the primary surface of the first wall section 11 opposite the second wall section 12 or the primary surface of the second wall section 12 opposite the first wall section 11. Specifically, in the present embodiment, the detection electrode 40 is disposed on the primary surface of the second wall section 12 opposite the first wall section 11.

The deflection electrode 50 is located closer to the outlet than are the voltage application electrodes 31, 32 with respect to the x-axis direction. The deflection electrode 50 is disposed opposite the detection electrode 40 across the flow path 10a. Specifically, in the present embodiment, the deflection electrode 50 is disposed on the primary surface of the first wall section 11 opposite the second wall section 12. The deflection electrode 50 generates a DC electric field that moves the ions I in the direction of the detection electrode 40 (the z2 side with respect to the z-axis direction). In other words, a voltage is applied to the deflection electrode 50 to generate a DC electric field that moves the ions I toward the detection electrode 40.

The reference electrode 60 is disposed in a location that is not opposite the deflection electrode 50. The reference electrode 60 is preferably located not opposite an electrically conductive member with respect to the normal to a primary surface 60a of the reference electrode 60.

The reference electrode 60 may be located anywhere along the x-axis direction, but is preferably located closer to the outlet (x2) than are the voltage application electrodes 31, 32 with respect to the x-axis direction. The reference electrode 60 is preferably located adjacent to the detection electrode 40 with respect to the x-axis direction along which the flow path 10a extends. In other words, there is no electrically conductive member located between the reference electrode 60 and the detection electrode 40 with respect to the x-axis direction.

In the present embodiment, specifically, the reference electrode 60 is disposed on the primary surface of the second wall section 12 opposite the first wall section 11. The reference electrode 60 is located between the detection electrode 40 and the second voltage application electrode 32 with respect to the x-axis direction. The reference electrode 60 preferably has a smaller width in the x-axis direction than the detection electrode 40 has a width in the x-axis direction.

The control unit 70 is connected to the sample feeding unit (not shown), the ionization unit 20, the voltage application electrodes 31, 32, the detection electrode 40, the deflection electrode 50, the reference electrode 60, and the pump (not shown).

The control unit 70 includes a generation unit 71. The generation unit 71 is connected to the first voltage application electrode 31. The generation unit 71 supplies an asymmetric-waveform, high-frequency voltage to the first voltage application electrode 31. An “asymmetric-waveform, high-frequency voltage” is a high-frequency voltage in which negative and positive voltages have different waveforms from each other.

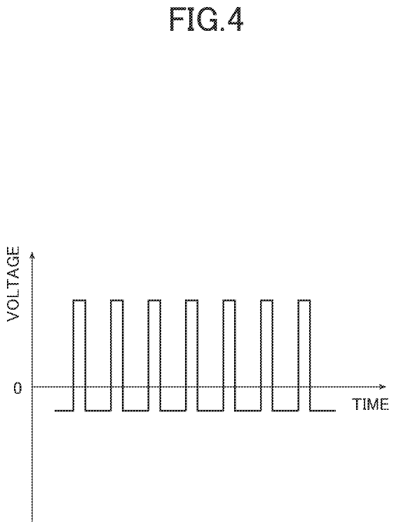

FIG. 4 shows an exemplary asymmetric-waveform, high-frequency voltage. In the high-frequency voltage shown in FIG. 4, the positive electrical potential has a different absolute value than does the negative electrical potential, and the positive voltage is applied for a different duration than is the negative voltage. These factors produce a high-frequency intense voltage with an asymmetric waveform. In addition, the area A of the region surrounded by 0 V and a portion of the waveform representing the high-frequency voltage that is located on the positive electrical potential side may differ from the area B of the region surrounded by 0 V and a portion of the waveform representing the high-frequency voltage that is located on the negative electrical potential side. The basic waveform preferably has a waveform where the areas A and B are equal.

Ion Analysis with Analyzer 1

A description will be given next of how the analyzer 1 analyzes ions.

Upon being fed to the flow path 10a, the sample S first passes a region where the ionization unit 20 is provided. The sample S is ionized in the ionization unit 20. Specifically, it is the ionizable molecules in the sample S that are ionized in the ionization unit 20. This ionization produces the ions I. The sample S typically contains a plurality of ionizable molecular species. A plurality of species of ions I is hence produced in the ionization unit 20.

The produced ions I are fed to a region where the voltage application electrodes 31, 32 are provided. An asymmetric-waveform, high-frequency voltage is applied to the voltage application electrodes 31, 32, as described above.

For instance, when the electrical potential of the high-frequency voltage applied to the voltage application electrodes 31, 32 increases to or beyond a certain predetermined value, each species of ions I exhibits a mobility with different non-linearity under the intense electric field generated by the electrical potential. Therefore, even when the high-frequency voltage has a basic waveform where the area A obtained by multiplying the positive electrical potential and the duration of application of the potential is equal to the area B obtained by multiplying the negative electrical potential and the duration of application of the potential, different species of ions have different projections. The projection of each ionic species can be altered by applying a positive or negative offset electrical potential, as well as the electrical potential applied by the high-frequency voltage with a basic waveform, to the voltage application electrodes 31, 32. A specific species of ions I can be hence selectively guided to pass the region where the voltage application electrodes 31, 32 are provided.

Additionally, more data can be collected to identify the gaseous species as the sample S by, for example, changing the high-frequency voltage waveform stepwise from a low absolute electrical potential to a high absolute electrical potential by means of the non-linear mobility, while maintaining the “A=B” relation for the positive and negative electrical potentials, and collecting data on the ionic species detected when the offset voltage is changed in each step.

After having passed the region where the voltage application electrodes 31, 32 are provided, the ions I reach a region where the deflection electrode 50 and the detection electrode 40 are provided. The ions I are then moved toward the detection electrode 40 under the DC electric field generated by the deflection electrode 50 and captured by the detection electrode 40. An electric current is generated in the detection electrode 40 in accordance with the quantity of the captured ions I. The concentration of the ions I can be analyzed by detecting this electric current.

Specifically, the detection electrode 40 is connected to a calculation unit 72 provided in the control unit 70 in the present embodiment. The calculation unit 72 calculates the concentration of the ions I in the sample S on the basis of a detection value (specifically, current value) acquired using the detection electrode 40.

More specifically, the calculation unit 72 is connected also to the reference electrode 60. The calculation unit 72 calculates the concentration of the ions I from the value (corrected current value) obtained by correcting the detection value (current value) acquired using the detection electrode 40 on the basis of the detection value (current value) acquired using the reference electrode 60.

For instance, the calculation unit 72 may calculate an ion concentration on the basis of the value obtained by subtracting the current value detected using the reference electrode 60 (or a value obtained by multiplying the current value detected using the reference electrode 60 by a prescribed coefficient) from the current value detected using the detection electrode 40.

A high-frequency voltage is applied to the voltage application electrodes 31, 32 in the analyzer 1, which produces high-frequency noise N that can affect the detection electrode 40. Therefore, the high-frequency noise N, as well as the captured ions I, can generate an electric current in the detection electrode 40. Therefore, when, for example, the ion concentration is calculated only from the magnitude of the electric current generated in the detection electrode 40, the calculated ion concentration is affected by the high-frequency noise N. It is hence difficult to analyze ion concentration with high precision.

The analyzer 1 includes the reference electrode 60 to address this problem. Since the reference electrode 60 is not located opposite the deflection electrode 50, the ions I are practically not captured by the reference electrode 60. No electric current generated in the reference electrode 60 is hence attributable to the captured ions I. All the electric current generated in the reference electrode 60 is attributable to the high-frequency noise N. The electric current generated by the high-frequency noise N can be hence obtained by detecting the electric current generated in the reference electrode 60. The analyzer 1 can reduce the adverse effects of the high-frequency noise N by using the detection value (current value) acquired using the detection electrode 40 and the detection value (current value) acquired using the reference electrode 60. The analyzer 1 can thus analyze the concentration of the ions I with high precision.

From the viewpoint of further reducing the adverse effects of the high-frequency noise N, there is preferably a small difference between the magnitude of the electric current generated by the high-frequency noise N in the detection electrode 40 and the magnitude of the electric current generated by the high-frequency noise N in the reference electrode 60. Therefore, there is preferably a small difference between the distance separating the voltage application electrodes 31, 32 from the detection electrode 40 and the distance separating the voltage application electrodes 31, 32 from the reference electrode 60, and more specifically, in the present embodiment, there is preferably a small difference between the distance separating the first voltage application electrode 31 to which the high-frequency voltage is applied from the detection electrode 40 and the distance separating the first voltage application electrode 31 from the reference electrode 60. The reference electrode 60 is hence preferably located closer to the x2 (outlet) than are the voltage application electrodes 31, 32 with respect to the x-axis direction, similarly to the detection electrode 40. The reference electrode 60 is preferably located adjacent to the detection electrode 40 with respect to the x-axis direction along which the flow path 10a extends.

Additionally, both the detection electrode 40 and the reference electrode 60 are preferably provided on the second wall section 12. When this is the case, the first voltage application electrode 31 to which the high-frequency voltage is applied is preferably provided on the first wall section 11, not on the second wall section 12 where the detection electrode 40 and the reference electrode 60 are provided. When this is the case, distance can be increased between the first voltage application electrode 31 and the detection electrode 40 and between the first voltage application electrode 31 and the reference electrode 60. The adverse effects of the high-frequency noise N on the detection electrode 40 and the reference electrode 60 can be thus reduced.

In addition, the concentration of the ions I is preferably calculated after the detection value (current value) acquired using the detection electrode 40 is corrected on the basis of the corrected current value obtained by correcting the detection value (current value) acquired using the reference electrode 60 in view of the distance separating the first voltage application electrode 31 to which the high-frequency voltage is applied from the detection electrode 40 and the distance separating the first voltage application electrode 31 from the reference electrode 60. When this is the case, the ion concentration can be calculated with high precision even when there is an appreciable difference between the distance separating the first voltage application electrode 31 to which the high-frequency voltage is applied from the detection electrode 40 and the distance separating the first voltage application electrode 31 from the reference electrode 60.

The following will describe other examples of a preferred embodiment of the present invention. Members of the embodiments that are practically the same as those in the first embodiment are indicated by the same reference signs or numerals, and detailed description thereof is omitted.

### Second Embodiment

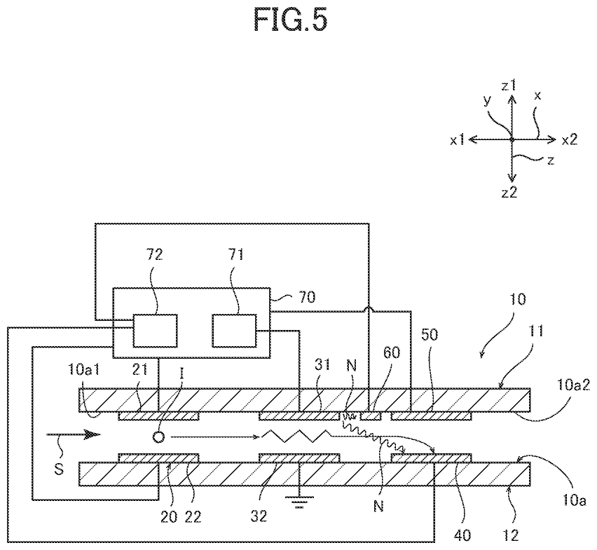

FIG. 5 is a schematic cross-sectional view of an analyzer in accordance with a second embodiment.

The first embodiment has described an example where the reference electrode 60 is located on the second wall section 12, that is, the one of the first and second wall sections 11, 12 on which the detection electrode 40 is provided. The present invention is not limited to this structure. As an alternative example, the reference electrode 60 may be located on the one of the first and second wall sections 11, 12 on which no detection electrode 40 is provided, or more specifically, on the primary surface of the first wall section 11 opposite the second wall section 12, as shown in FIG. 5.

This particular structure can reduce the distance separating the first voltage application electrode 31 to which the high-frequency voltage is applied from the reference electrode 60.

### Third Embodiment

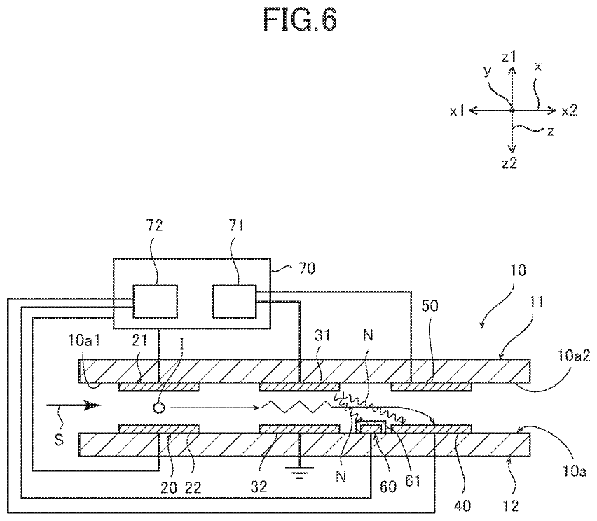

FIG. 6 is a schematic cross-sectional view of an analyzer in accordance with a third embodiment.

The analyzer shown in FIG. 6 includes a film 61 covering the reference electrode 60. The film 61 serves as, for example, an ion barrier film, thereby more effectively restraining the reference electrode 60 from capturing the ions I. The reference electrode 60 thus enables more selective detection of the high-frequency noise N with high precision. The analyzer in accordance with the present embodiment can hence exhibit further improved precision in ionic concentration analysis.

The film 61 may be, for example, an organic film or an inorganic film such as a silicon oxide film or a silicon nitride film.

### Fourth Embodiment

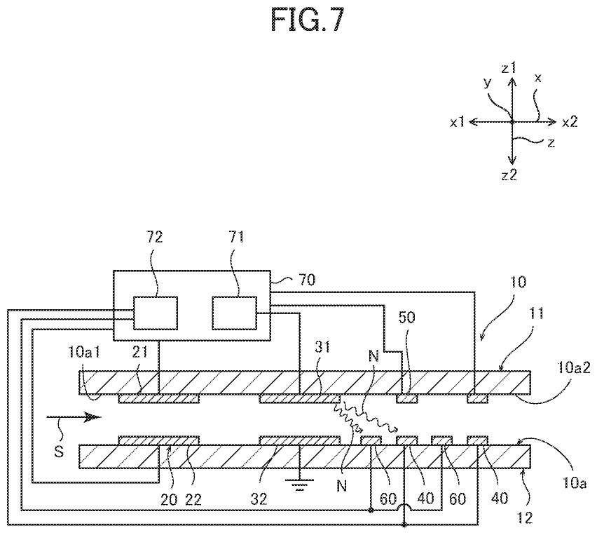

FIG. 7 is a schematic cross-sectional view of an analyzer in accordance with a fourth embodiment.

Referring to FIG. 7, the analyzer in accordance with the fourth embodiment includes a plurality of detection electrodes 40 arranged along the x-axis direction along which the flow path 10a extends. There are provided reference electrodes 60, one between each pair of detection electrodes 40 that are adjacent to each other in the x-axis direction. This particular structure can reduce the difference between the distance separating the first voltage application electrode 31 to which the high-frequency voltage is applied from the detection electrode 40 and the distance separating the first voltage application electrode 31 from the reference electrode 60. The analyzer in accordance with the present embodiment can hence exhibit further improved precision in ionic concentration analysis.

More specifically, the present embodiment includes a plurality of reference electrodes 60 arranged along the x-axis direction. The reference electrodes 60 and the detection electrodes 40 alternate when traced along the x-axis direction. The reference electrodes 60 thus enables more suitable detection of the high-frequency noise N, thereby further improving precision in ionic concentration analysis.

### Fifth and Sixth Embodiments

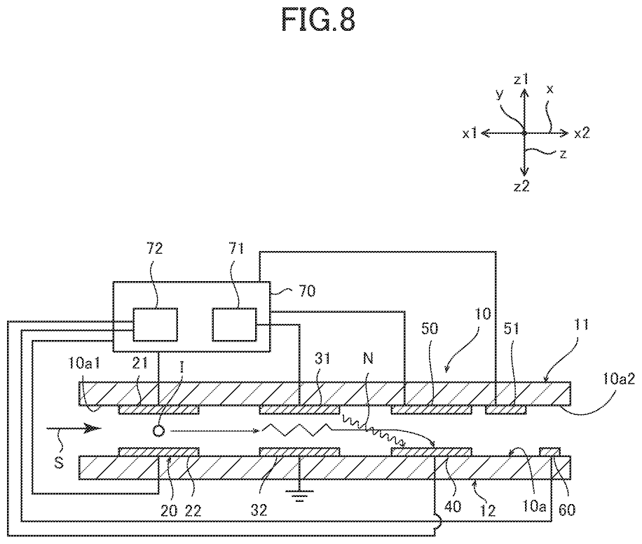

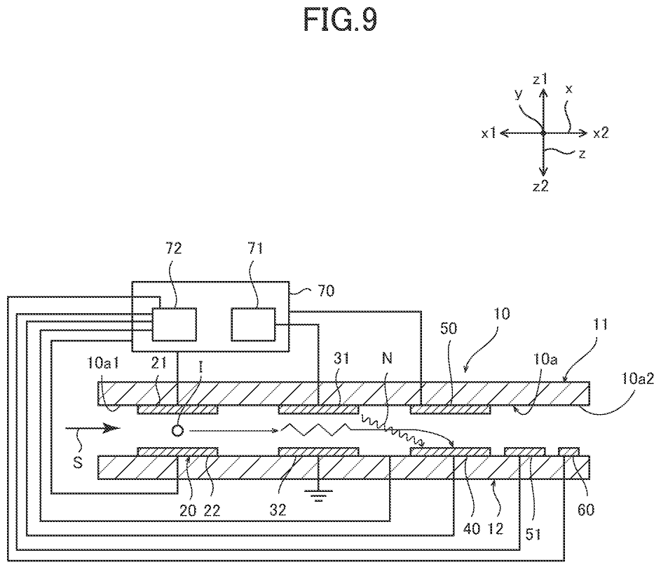

FIG. 8 is a schematic cross-sectional view of an analyzer in accordance with a fifth embodiment. FIG. 9 is a schematic cross-sectional view of an analyzer in accordance with a sixth embodiment.

Referring to FIGS. 8 and 9, the analyzers in accordance with the fifth and sixth embodiments include an additional deflection electrode 51 closer to the x2 (outlet) than are the detection electrode 40 and the deflection electrode 50 with respect to the x-axis direction. The additional deflection electrode 51 is provided on one of the first wall section 11 and the second wall section 12 so as to generate a DC electric field that moves the ions I toward the other one of the first wall section 11 and the second wall section 12. Specifically, in the fifth embodiment, the additional deflection electrode 51 is provided on the primary surface of the first wall section 11 opposite the second wall section 12 so as to generate a DC electric field that moves the ions I toward the second wall section 12 as shown in FIG. 8. Meanwhile, in the sixth embodiment, the additional deflection electrode 51 is provided on the primary surface of the second wall section 12 opposite the first wall section 11 so as to generate a DC electric field that moves the ions I toward the first wall section 11 as shown in FIG. 9.

The reference electrode 60 is located closer to the x2 (outlet) than is the additional deflection electrode 51 with respect to the x-axis direction in the fifth and sixth embodiments. In other words, the additional deflection electrode 51 is located between the reference electrode 60 and the set of the detection electrode 40 and the deflection electrode 50 with respect to the x-axis direction. The provision of the additional deflection electrode 51 enables more effective prevention of the ions I from reaching the detection electrode 40. This particular structure can thus restrain electric current from being generated by the ions I captured by the reference electrode 60. The current generated in the reference electrode 60 primarily comes from the high-frequency noise N. The reference electrode 60 thus enables more suitable detection of the high-frequency noise N, thereby further improving precision in ionic concentration analysis.

### Seventh Embodiment

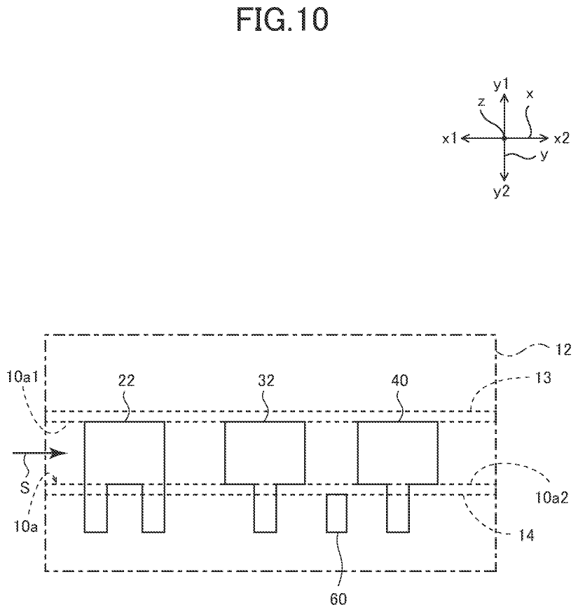

FIG. 10 is a schematic plan view of a second wall section in accordance with a seventh embodiment.

The previous embodiments have described an example where the reference electrode(s) 60 are disposed inside the flow path 10a. The reference electrode(s) 60 may be disposed anywhere in the present invention so long as the reference electrode(s) 60 enable detection of the high-frequency noise N.

Referring to FIG. 10, the reference electrode 60 is disposed outside the flow path 10a in the seventh embodiment. The reference electrode 60, disposed in such a location, can still improve precision in ionic concentration analysis so long as the reference electrode 60 enables detection of the high-frequency noise N.

The provision of the reference electrode 60 outside the flow path 10a as in the present embodiment enables more effective prevention of the ions I from being captured by the reference electrode 60. The reference electrode 60 thus enables more suitable detection of the high-frequency noise N, thereby further improving precision in ionic concentration analysis.

### Eighth Embodiment

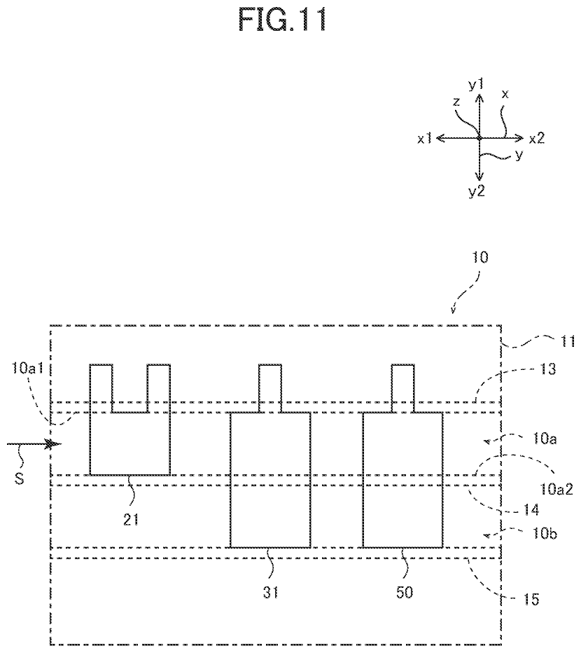

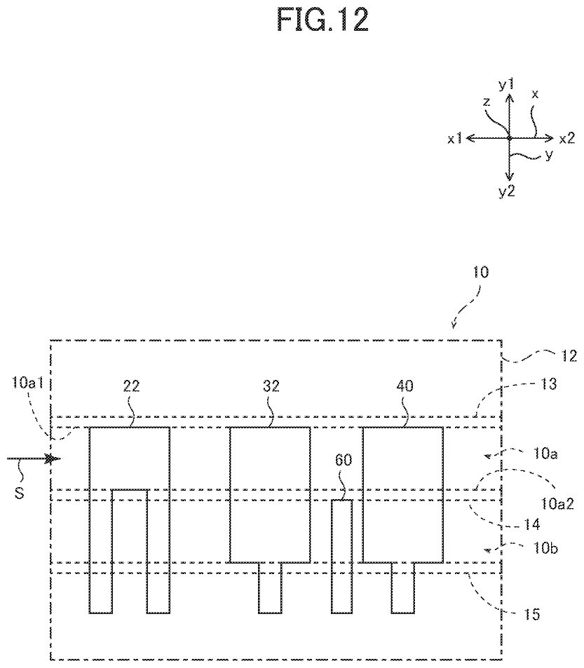

FIG. 11 is a schematic plan view of a first wall section in accordance with an eighth embodiment. FIG. 12 is a schematic plan view of a second wall section in accordance with the eighth embodiment.

Referring to FIGS. 11 and 12, the flow path component 10 is a part of an additional flow path 10b that is isolated from the flow path 10a in the eighth embodiment. Specifically, the flow path component 10 includes a third sidewall section 15. The third sidewall section 15 is provided between the first wall section 11 and the second wall section 12. The third sidewall section 15 is on the opposite side of the second sidewall section 14 from the first sidewall section 13. The third sidewall section 15 extends along the x-axis direction. Hence, the first wall section 11, the second wall section 12, the second sidewall section 14, and the third sidewall section 15 form the additional flow path 10b.

The voltage application electrodes 31, 32 are provided straddling both the flow path 10a and the additional flow path 10b. The detection electrode 40 and the deflection electrode 50 are also provided straddling both the flow path 10a and the additional flow path 10b in the present embodiment.

Referring to FIG. 12, the reference electrode 60 is provided in the additional flow path 10b, not in the flow path 10a.

In the present embodiment, the provision of the reference electrode 60 outside the flow path 10a again enables effective prevention of the ions I from being captured by the reference electrode 60. The reference electrode 60 thus enables more suitable detection of the high-frequency noise N, thereby further improving precision in ionic concentration analysis.

What is claimed is:

1. An analyzer comprising:
a flow path component providing a flow path through which a sample is supplied from an inlet end thereof toward an outlet end thereof;
an ionization unit that ionizes the sample flowing in the flow path to produce ions;
a pair of voltage application electrodes located opposite each other across the flow path and closer to the outlet end than the ionization unit is located close to the outlet end, an asymmetric-waveform, high-frequency voltage being applied to the pair of voltage application electrodes;
a detection electrode located inside the flow path and closer to the outlet end than the pair of voltage application electrodes is located close to the outlet end;
a deflection electrode located opposite the detection electrode across the flow path, the deflection electrode generating a DC electric field that moves the ions toward the detection electrode; and
a reference electrode located not opposite the deflection electrode.

2. The analyzer according to claim 1, wherein the reference electrode is located closer to the outlet end than the pair of voltage application electrodes is located close to the outlet end.

3. The analyzer according to claim 1, wherein the reference electrode is located adjacent to the detection electrode with respect to a direction along which the flow path extends.

4. The analyzer according to claim 1, further comprising a film covering the reference electrode.

5. The analyzer according to claim 1, wherein
the flow path component includes a first wall section and a second wall section located opposite each other across the flow path,
the pair of voltage application electrodes includes:
a first electrode located on the first wall section, the asymmetric-waveform, high-frequency voltage being applied to the first electrode; and
a second electrode located on the second wall section and opposite the first electrode across the flow path, and
the detection electrode is located on the second wall section.

6. The analyzer according to claim 5, wherein the reference electrode is located on the second wall section.

7. The analyzer according to claim 6, further comprising an additional deflection electrode located on either one of the first wall section and the second wall section and closer to the outlet end than the detection electrode and the deflection electrode are located close to the outlet end, the additional deflection electrode generating a DC electric field that moves the ions toward another one of the first wall section and the second wall section, wherein
the reference electrode is located closer to the outlet end than the additional deflection electrode is located close to the outlet end.

8. The analyzer according to claim 5, wherein the reference electrode is located on the first wall section.

9. The analyzer according to claim 1, wherein
the detection electrode includes a plurality of detection electrodes arranged along a direction along which the flow path extends, and
the reference electrode is located between those detection electrodes that are adjacent to each other with respect to the direction along which the flow path extends.

10. The analyzer according to claim 9, wherein
the analyzer includes a plurality of the reference electrode, and
the reference electrodes and the detection electrodes are provided alternately with respect to the direction along which the flow path extends.

11. The analyzer according to claim 1, wherein the reference electrode is located outside the flow path.

12. The analyzer according to claim 1, wherein
the flow path component forms another flow path isolated from the flow path,
the pair of voltage application electrodes is provided straddling both the flow path and the other flow path,
the reference electrode is located in the other flow path.

13. The analyzer according to claim 1, further comprising a calculation unit configured to calculate an ion concentration based on a value obtained by correcting a detection value acquired using the detection electrode based on a detection value acquired using the reference electrode.

14. The analyzer according to claim 13, wherein the calculation unit calculates the ion concentration based on a value obtained by subtracting a current value detected using the reference electrode from a current value detected using the detection electrode.
